(19) United States
(12) Patent Application Publication
(10) Pub. No.: US 2014/0149868 A1
(43) Pub. Date: May 29, 2014

(54) METHOD AND SYSTEM FOR PROVIDING AUDIO ASSISTANCE FOR NON-VISUAL NAVIGATION OF DATA

(71) Applicants: Sourabh DUBEY, Bangalore (IN); Vineeth Anand Nair, Bangalore (IN)

(72) Inventors: Sourabh DUBEY, Bangalore (IN); Vineeth Anand Nair, Bangalore (IN)

(73) Assignee: Yahoo! Inc., Sunnyvale, CA (US)

(21) Appl. No.: 13/686,926

(22) Filed: Nov. 28, 2012

(51) Int. Cl. G06F 3/048

(52) U.S. Cl. CPC G06F 3/048
USPC 715/727

(57) ABSTRACT

A method and system for providing audio assistance for non-visual navigation of data. The method includes receiving a scroll input; determining a page length associated with the data; associating the page length with a plurality of steps; associating an audio pattern to each step; determining a step, of the plurality of steps, that corresponds to the scroll input; and playing, to the user, the audio pattern corresponding to the step. The system includes an electronic device, a communication interface, a memory and a processor to receive a scroll input, to determine a page length associated with the data, to associate the page length with a plurality of steps, to associate an audio pattern to each step, to determine a step, of the plurality of steps, that corresponds to the scroll input and to play, to the user, the audio pattern corresponding to the step.

### TECHNICAL FIELD

Embodiments of the disclosure relate to the field of providing audio assistance during non-visual navigation of data.

### BACKGROUND

In recent times, electronic devices, for example mobile phones and tablets, are increasingly used to access data present on a page, for example a webpage. Primarily, navigation of the data, by a user of such electronic devices, is performed by scrolling through the data. Conventional methods employ a screen reader application for presenting the data during non-visual navigation of the data. In one example, the screen reader application converts text, included in the data, to audio content, for example speech. Hence, the user is enabled to interpret the data without viewing the data. However, the user is unable to determine extent of scrolling and often loses track as to how deep the user is on the page. As a result, the user is required to listen to the audio content completely in order to determine if the user has reached end of the page which is time consuming.

In the light of the foregoing discussion, there is a need for an efficient method and a system for providing audio assistance during non-visual navigation of data.

### SUMMARY

The above-mentioned needs are met by a method, a computer program product and a system for providing audio assistance for non-visual navigation of data.

An example of a method of providing audio assistance for non-visual navigation of data includes receiving a scroll input from a user of an electronic device. The scroll input is being provided to a graphical user interface for accessing the data on a page. The method also includes determining a page length associated with the data. The method further includes associating the page length with a plurality of steps. Each step, of the plurality of steps, is associated with a corresponding step size. The corresponding step size is being varied proportionally to the page length associated with the data. Further, the method includes associating an audio pattern to each step. Furthermore, the method includes determining a step, of the plurality of steps, that corresponds to the scroll input. Moreover, the method includes playing, to the user, the audio pattern corresponding to the step. The audio pattern indicates a page position associated with the scroll input on the page.

An example of a computer program product stored on a non-transitory computer-readable medium that when executed by a processor, performs a method of providing audio assistance for non-visual navigation of data includes receiving a scroll input from a user of an electronic device. The scroll input is being provided to a graphical user interface for accessing the data on a page. The computer program product also includes determining a page length associated with the data. The computer program product further includes associating the page length with a plurality of steps. Each step, of the plurality of steps, is associated with a corresponding step size. The corresponding step size is being varied proportionally to the page length associated with the data. Further, the computer program product includes associating an audio pattern to each step. Furthermore, the computer program product includes determining a step, of the plurality of steps, that corresponds to the scroll input. Moreover, the computer program product includes playing, to the user, the audio pattern corresponding to the step. The audio pattern indicates a page position associated with the scroll input on the page.

An example of a system for providing audio assistance for non-visual navigation of data includes an electronic device. The system also includes a communication interface in electronic communication with the electronic device. The system further includes a memory that stores instructions. Further, the system includes a processor responsive to the instructions to receive a scroll input from a user of an electronic device. The scroll input is being provided to a graphical user interface for accessing the data on a page. The processor is also responsive to the instructions to determine a page length associated with the data. The processor is further responsive to the instructions to associate the page length with a plurality of steps. Each step, of the plurality of steps, is associated with a corresponding step size. The corresponding step size is being varied proportionally to the page length associated with the data. Further, the processor is responsive to the instructions to associate an audio pattern to each step. Furthermore the processor is responsive to the instructions to determine a step, of the plurality of steps, that corresponds to the scroll input. Moreover, the processor is responsive to the instructions to play, to the user, the audio pattern corresponding to the step. The audio pattern indicates a page position associated with the scroll input on the page.

### BRIEF DESCRIPTION OF THE FIGURES

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of an environment, in accordance with which various embodiments can be implemented;

FIG. 2 is a block diagram of a server, in accordance with one embodiment; and

FIG. 3 is a flow diagram illustrating a method of providing audio assistance for non-visual navigation of data, in accordance with one embodiment.

### DETAILED DESCRIPTION OF THE EMBODIMENTS

The above-mentioned needs are met by a method, computer program product and system for providing audio assistance for non-visual navigation of data. The following detailed description is intended to provide example implementations to one of ordinary skill in the art, and is not intended to limit the invention to the explicit disclosure, as one or ordinary skill in the art will understand that variations can be substituted that are within the scope of the invention as described.

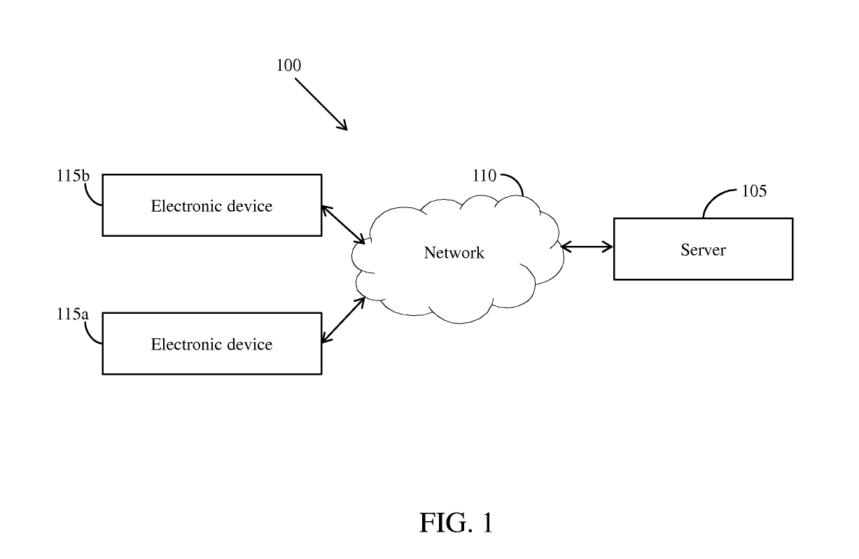

FIG. 1 is a block diagram of an environment 100, in accordance with which various embodiments can be implemented.

The environment 100 includes a server 105 connected to a network 110. The environment 100 further includes one or more electronic devices, for example an electronic device 115a and an electronic device 115b, which can communicate with each other through the network 110. Examples of the electronic devices include, but are not limited to, computers, mobile devices, tablets, laptops, palmtops, hand held devices, telecommunication devices, and personal digital assistants (PDAs).

The server 105 is in electronic communication with the electronic device 115a and the electronic device 115b through the network 110. The server 105 can be located remotely with respect to the electronic device 115. Examples of the network 110 include, but are not limited to, a Local Area Network (LAN), a Wireless Local Area Network (WLAN), a Wide Area Network (WAN), internet, and a Small Area Network (SAN).

In some embodiments, an electronic device 115a can perform functions of the server 105.

A user of the electronic device 115a provides a scroll input for accessing the data on a page, for example Yahoo!@ webpage. The server 105 upon receiving the scroll input determines a page length associated with the data. The server 105 also associates the page length with a plurality of steps. The server 105 further associates an audio pattern to each step. Further, the server 105 determines a step, of the plurality of steps, that corresponds to the scroll input. The step is varied based on the scroll input. Upon determining the step, the server 105 plays, to the user, the audio pattern that corresponds to the step. The audio pattern corresponding to the step indicates a page position, associated with the scroll input, on the page. The audio pattern is varied with respect to the step. Hence, the audio pattern enables the user to determine a degree of scroll with respect to the page length without viewing the data on the page.

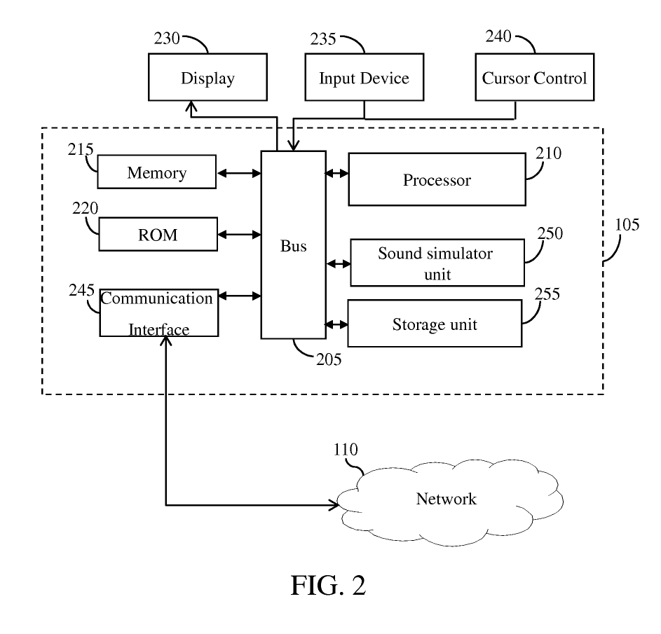

A server 105 including a plurality of elements is explained in detail in conjunction with FIG. 2.

FIG. 2 is a block diagram of the server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example a plurality of steps and various audio patterns corresponding to the steps.

The server 105 can be coupled via the bus 205 to a display 230, for example a cathode ray tube (CRT), for displaying data. The input device 235, including alphanumeric and other keys, is coupled to the bus 205 for communicating information and command selections to the processor 210. Another type of user input device is the cursor control 240, for example a mouse, a trackball, or cursor direction keys for communicating direction information and command selections to the processor 210 and for controlling cursor movement on the display 230.

Various embodiments are related to the use of the server 105 for implementing the techniques described herein. In some embodiments, the techniques are performed by the server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, for example the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that include the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. In any such implementation, the communication interface 245 sends and receives electrical, electromagnetic or optical signals that carry digital data streams representing various types of information.

The server 105 further includes a sound simulator unit 250. The sound simulator unit 250 is used to simulate the various audio patterns.

The processor 210 in the server 105 is configured to receive a scroll input from a user of the electronic device 105a. The scroll input is provided to a graphical user interface of the electronic device 105a for accessing data on a page. The scroll input includes a vertical scroll input or a horizontal scroll input.

The processor 210, upon receiving the scroll input, determines a page length associated with the data on the page. One or more web scripting languages, for example a java script language, can be used for determining the page length.

The processor 210 is also configured to associate the page length with a plurality of steps. The processor 210 assigns a corresponding step size to each step. The corresponding step size is varied proportionally to the page length associated with the data. In one example, the corresponding step size associated with each step can be logarithmically proportional to the page length.

Further, the processor 210 is operable to associate an audio pattern to each step. The audio pattern is simulated using the sound simulator unit 250. Further the processor 210 is operable to vary the audio pattern with respect to each step.

The processor 210 is also configured to determine a step, of the plurality of steps, that corresponds to the scroll input. Further, the processor 210 is operable to play the audio pattern corresponding to the step determined. The audio pattern indicates a page position, associated with the scroll input, on the page. The page position indicates a degree of scroll, obtained upon provision of the scroll input, with respect to the page length.

By playing the audio pattern, the user can track the page position without viewing the data on the page. Hence, in one example, by listening to the audio pattern, a visually challenged user can also determine the page position with respect to beginning of the page or bottom of the page.

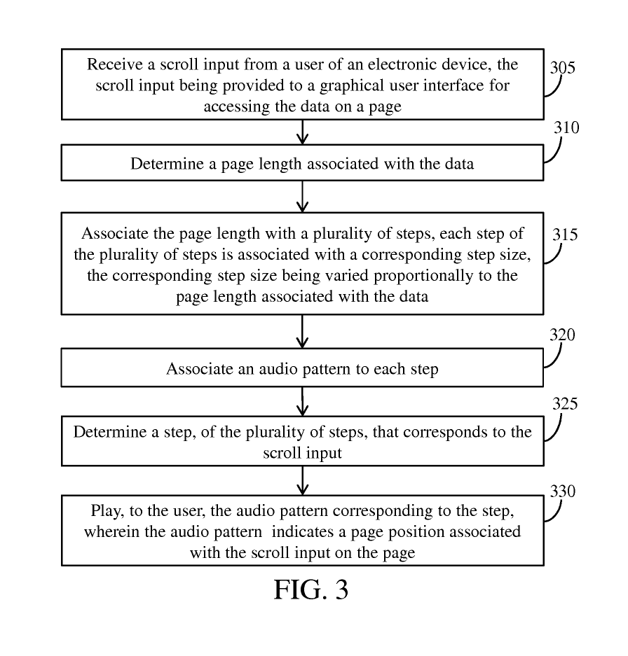

A method of providing audio assistance for non-visual navigation of data, is explained in detail in conjunction with FIG. 3.

FIG. 3 is a flow diagram illustrating a method of providing audio assistance for non-visual navigation of data, in accordance with one embodiment.

At step 305, a scroll input is received from a user of an electronic device, for example the electronic device 115a. The scroll input is provided to a graphical user interface (GUI), of the electronic device, for accessing the data on a page. The scroll input can be provided using one or more input modes. Examples of the one or more input modes include, but are not limited to, a human finger, a stylus and a mouse. Examples of the page include, but are not limited to, a webpage, a memory page and a word document. Various sections of the data can be accessed based on the scroll input provided by the user.

The scroll input includes a vertical scroll input or a horizontal scroll input. The vertical scroll input can be used for accessing the data present on the page. The horizontal scroll input can be used for accessing various webpages and data files that stores the data. The data files are stored in a memory of the electronic device.

At step 310, a page length associated with the data is determined. The page length represents extension of the data on the page. In one example, the page length can be determined by identifying number of lines, of the data, included in the page.

At step 315, the page length is associated with a plurality of steps. Each step is associated with a corresponding step size. The corresponding step size is varied proportionally to the page length. In one example, the corresponding step size associated with each step can be logarithmically proportional to the page length. The steps are used to track a page position associated with the scroll input on the page.

At step 320, an audio pattern is associated with each step. The audio pattern is created by simulating sound. In one example, the audio pattern can include the sound being repeated at a pre-defined time interval. In another example, the audio pattern can include sounds with varying frequencies.

The audio pattern is varied with respect to each step. Each step is associated with the audio pattern such that the user can distinguish different page positions from each other without viewing the page.

In one example, the audio pattern associated with a step that is located relatively proximal to beginning of the page can include the sound that is repeated at the pre-defined time interval of 5 milliseconds. In another example, the audio pattern associated with a step that is located relatively proximal to bottom of the page can include the sound that is repeated at the pre-defined time interval of 15 milliseconds.

At step 325, a step, of the steps, that corresponds to the scroll input is determined. The step is varied based on the scroll input.

At step 330, the audio pattern corresponding to the step determined at step 325 is played to the user. The audio pattern indicates, to the user, the page position associated with the scroll input on the page. The page position indicates a degree of scroll, obtained upon provision of the scroll input, relative to the beginning of the page or the bottom of the page.

In one example, if the step that corresponds to the scroll input is located relatively proximal to the bottom of the page, then the audio pattern including the sound that is repeated at the pre-defined time interval of 15 milliseconds is played to the user. The audio pattern indicates that the page position is relatively proximal to the bottom of the page. Hence an inference that the user has reached the bottom of the page is obtained.

The method specified in the present disclosure enables provision of audio assistance for non-visual navigation of data. By listening to the audio pattern, the user can determine the degree of scroll without viewing the page. Hence, the user can track the page position with respect to the beginning of the page or the bottom of the page. Therefore, in one example, the method enables visually challenged users, using electronic devices, to track the page position during navigation of the data. Thereby, an enhanced user experience is provided during the non-visual navigation of the data.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of providing audio assistance for non-visual navigation of data, the method comprising:
receiving a scroll input from a user of an electronic device, the scroll input being provided to a graphical user interface for accessing the data on a page;
determining a page length associated with the data;
associating the page length with a plurality of steps, wherein each step of the plurality of steps is associated with a corresponding step size, the corresponding step size being varied proportionally to the page length associated with the data;
associating an audio pattern to each step;
determining a step, of the plurality of steps, that corresponds to the scroll input; and
playing, to the user, the audio pattern corresponding to the step, wherein the audio pattern indicates a page position associated with the scroll input on the page.

2. The method as claimed in claim 1, wherein the scroll input comprises one of a vertical scroll input and a horizontal scroll input.

3. The method as claimed in claim 2, wherein the vertical scroll input is used to access the data stored in a data file.

4. The method as claimed in claim 2, wherein the horizontal scroll input is used to access one of a plurality of data files present in a memory of the electronic device and a plurality of webpages.

5. The method as claimed in claim 1 and further comprising
simulating sound to create the audio pattern.

6. The method as claimed in claim 1, wherein the step varies in accordance to the scroll input.

7. The method as claimed in claim 1, wherein the audio pattern varies in accordance to each step of the plurality of steps.

8. A computer program product stored on a non-transitory computer-readable medium that when executed by a processor, performs a method of providing audio assistance for non-visual navigation of data, the method comprising:
receiving a scroll input from a user of an electronic device, the scroll input being provided to a graphical user interface for accessing the data on a page;
determining a page length associated with the data;
associating the page length with a plurality of steps, wherein each step of the plurality of steps is associated with a corresponding step size, the corresponding step size being varied proportionally to the page length associated with the data;
associating an audio pattern to each step;
determining a step, of the plurality of steps, that corresponds to the scroll input; and
playing, to the user, the audio pattern corresponding to the step, wherein the audio pattern indicates a page position associated with the scroll input on the page.

9. The computer program product as claimed in claim 8, wherein the scroll input comprises one of a vertical scroll input and a horizontal scroll input.

10. The computer program product as claimed in claim 8, wherein the vertical scroll input is used to access the data stored in a data file.

11. The computer program product as claimed in claim 8, the horizontal scroll input is used to access one of a plurality of data files present in a memory of the electronic device and a plurality of webpages.

12. The computer program product as claimed in claim 8 and further comprising
simulating sound to create the audio pattern.

13. The computer program product as claimed in claim 8, wherein the step varies in accordance to the scroll input.

14. The computer program product as claimed in claim 8, wherein the audio pattern varies in accordance to each step of the plurality of steps.

15. A system for providing audio assistance for non-visual navigation of data, the system comprising:
an electronic device;
a communication interface in electronic communication with the electronic device;
a memory that stores instructions; and
a processor responsive to the instructions to
receive a scroll input from a user of an electronic device, the scroll input being provided to a graphical user interface for accessing the data on a page;
determine a page length associated with the data;
associate the page length with a plurality of steps, wherein each step of the plurality of steps is associated with a corresponding step size, the corresponding step size being varied proportionally to the page length associated with the data;
associate an audio pattern to each step;
determine a step, of the plurality of steps, that corresponds to the scroll input; and
play, to the user, the audio pattern corresponding to the step, wherein the audio pattern indicates a page position associated with the scroll input on the page.

16. The system as claimed in claim 15, wherein the scroll input comprises one of a vertical scroll input and horizontal scroll input.

17. The system as claimed in claim 15 and further comprising:
a sound simulator unit that simulates the audio pattern.

18. The system as claimed in claim 15, wherein the audio pattern varies in accordance to each step of the plurality of steps.
